(19) United States
(12) Patent Application Publication
(10) Pub. No.: US 2020/0337301 A1
(43) Pub. Date: Oct. 29, 2020

(54) ANTIMICROBIAL COATING MATERIAL COMPRISING NANOCRYSTALLINE CELLULOSE AND MAGNESIUM OXIDE AND METHOD OF PREPARATION THEREOF

(71) Applicants: IMI TAMI INSTITUTE FOR RESEARCH AND DEVELOPMENT LTD, Kiriyat Ata (IL); MELODEA LTD., Rehovot (IL)

(72) Inventors: Ezra HANUKA, Nesher (IL); Chen ZOLKOV, Kiryat Tivon (IL); Yuval NEVO, Rehovot (IL); Clarite AZERAFF, Ashdod (IL)

(21) Appl. No.: 16/635,243

(22) PCT Filed: Jul. 30, 2018
(86) PCT No.: PCT/IL2018/050848

§ 371 Date: Jan. 30, 2020

Related U.S. Application Data
(60) Provisional application No. 62/538,717, filed on Jul. 30, 2017.

(51) Int. Cl. A01N 25/10; A01N 59/06; A01N 25/26

(52) U.S. Cl. CPC A01N 25/10; A01N 25/26; A01N 59/06

(57) ABSTRACT

A nontoxic antimicrobial chemical trap that comprises a film comprising an antimicrobial layer that comprises nanocrystalline cellulose (NCC) and an antimicrobial substance selected from the group consisting of MgO and Mg(OH)₂. In some embodiments, the antimicrobial trap comprises at least one additional layer of NCC above or below said antimicrobial layer. Methods of preparation of the antimicrobial chemical trap and of articles coated thereby are disclosed, as well as methods of controlling microbial population by use of the antimicrobial chemical trap, are disclosed as well.

### REFERENCE TO RELATED PUBLICATIONS

This application claims priority from U.S. Provisional Pat. Appl. No. 62/538,717, filed 30 Jul. 2017.

### FIELD OF THE INVENTION

This invention relates in general to antimicrobial coatings and films and to articles comprising such coatings. It relates in particular to a antimicrobial coatings and films made from nano-crystalline cellulose into which magnesium oxide or hydroxide is incorporated, to articles comprising at least one surface coated with such coatings, and to methods for applying the coatings and for producing the articles.

### BACKGROUND OF THE INVENTION

Resistance of bacteria to antibiotics has become a significant problem. A great deal of effort has been expended to find alternative methods of controlling bacteria.

Magnesium oxide is known to have antimicrobial properties. It is believed that in an aqueous environment, MgO catalytically forms active oxygen species such as peroxide, and these active oxygen species kill microbes with which they come into contact.

Various articles into which MgO is incorporated as an antimicrobial substance are known in the art. For example, U.S. Pat. No. 9,315,937 discloses a method for producing an antimicrobial fabric via sonochemical incorporation of MgO. Sanuja et al. (Int. J. Polym. Mater. Polym. Biomater. 2014, 63, 733) have reported preparation of a chitosan-magnesium oxide-based nanocomposite film containing clove oil by a solution cast method. Zheng et al. (Nanchang Daxue Xuebao, Gongkeban 2007, 29, 315; CA152:121924) have disclosed a sedimentation method for making a nano-MgO coating starting from Na₂CO₃ and MgCl2 and calcining to obtain nanoparticulate MgO.

Nanocrystalline cellulose (NCC) is a form of cellulose that is obtained under controlled conditions that lead to formation of high-purity single crystals. These crystals display extremely high mechanical strength that is equivalent to the binding forces of adjacent atoms. NCC is characterized by a Young's modulus of approximately 100-150 GPa and a tensile strength on the order of 10 GPa, values similar to those of materials such as aramid fibers (Kevlar) and carbon fibers, and a surface area on the order of several hundred m²/g. These properties have made NCC an attractive material for many purposes. U.S. Pat. Pub. No. 2015/00017432 discloses a method of making a coating comprising nanocrystalline cellulose into which nanoparticles have been incorporated. This method requires that the surface of the substrate onto which the coating is applied be positively charged so that the coating will be held in place by electrostatic interactions, and disposes the nanoparticles between the NCC layer and the surface of the substrate.

International (PCT) Pat. Appl. Pub. No. WO2017/199252 discloses a modified NCC film in which properties such as hygroscopicity can be tuned by the addition of one or more hygroscopic materials, OH-rich materials such as organic compounds containing three or more OH groups, and crosslinkers.

As a person of skill in the art would appreciate, controlling the position of particles such as nanoparticles or microparticles in or on a surface region of a material film acting as a matrix for holding the particles is not trivial. In many instances, for ensuring predefined or partial exposure of the particles above the surface region, the thickness of the material film must be limited, or the concentration of the particles must be increased to force the particles to the surface of the film. While other methodologies for ensuring at least partial exposure are available, films have been found to be limited in reproducibility, particle distribution and homogeneity.

In cases where surface activity intimately depends on surface density of active functionalities, namely where the activity increases with an increase in surface functionalities, as in the case of antimicrobial surfaces, and where surface exposure of such functionalities depends inter alia on processing conditions and material selection, there becomes a technological need to minimize the effect of or dependency on at least some of the processing conditions, so as to achieve process independent activity.

All of the methods known in the art for preparation of antimicrobial coatings that incorporate MgO as the active ingredients suffer from significant drawbacks such as a limited range of uses or expense or difficulty of preparation. Thus, a simple general method for producing an antibacterial coating that is strong and stable remains a long-felt, but as yet unmet need.

### SUMMARY OF THE INVENTION

The present invention is designed to meet this need. The inventors of the invention herein disclosed have developed a unique and innovative antimicrobial film comprising NCC as the matrix material particles of magnesium oxide (MgO) and/or magnesium hydroxide (Mg(OH)₂), substances known to have antimicrobial properties. The inventors have found that MgO films in which the matrix is made from a polymer such as polyethylene, no significant antimicrobial activity (i.e. no significant reduction in microbial population or reduction in the rate of growth of a microbial population) is observed. In contrast, not only does an MgO film in which the matrix comprises NCC show significant antimicrobial activity, the film maintains its antimicrobial properties independent of any processing methodology and processing conditions. In some embodiments, the film retains its antimicrobial activity even when the antimicrobial particles are embedded in, contained within, or coated by the matrix material, with limited or no direct exposure of the antimicrobial material at the surface of the film. In some embodiments, the film does not contain any OH-rich material. In some embodiments, the film does not contain any cross-linking agent.

The inventors of the instant invention have discovered that antimicrobial films comprising or consisting of MgO or Mg(OH)₂ and nanocrystalline cellulose can be applied to a large variety of substrates, and that a single general method for applying these films can be used for coating all of these different substrates. An improved method for producing an antimicrobial article comprising or consisting of a substrate and an antimicrobial coating comprising nanocrystalline cellulose and MgO and/or Mg(OH)₂ is disclosed, as are an antimicrobial article comprising a substrate upon at least one surface of which an antimicrobial coating comprising nanocrystalline cellulose and MgO and/or Mg(OH)₂ is dispersed, and a method for controlling microbial populations by exposing them to the article of the instant invention.

It is therefore an object of the present invention to disclose an antimicrobial chemical trap comprising or consisting of a film characterized by an upper surface and a lower surface, said film comprising or consisting of (a) an antimicrobial layer comprising nanocrystalline cellulose (NCC) and (b) particles of an antimicrobial substance selected from the group consisting of MgO, Mg(OH)₂, mixtures thereof, and combinations thereof, said particles at least partially embedded within said film. It is an object of the invention to disclose an antimicrobial film characterized by an upper surface and a lower surface, said film comprising or consisting of (a) an antimicrobial layer comprising nanocrystalline cellulose (NCC) and (b) particles of an antimicrobial substance selected from the group consisting of MgO, Mg(OH)₂, mixtures thereof, and combinations thereof, said particles at least partially embedded within said film. In some preferred embodiments of the invention, it does not comprise any substance that is not non-toxic. In some preferred embodiments of the invention, it does not comprise any OH-rich material. In some preferred embodiments of the invention, it does not comprise any crosslinking reagent or catalyst or any product of a cross-linking reaction.

It is a further object of this invention to disclose the antimicrobial chemical trap or film as defined in any of the above, wherein said particles of antimicrobial substance are at least partially coated with NCC.

It is a further object of this invention to disclose the antimicrobial chemical trap or film as defined above, wherein said particles of antimicrobial substance are at least partially exposed on said upper surface.

It is a further object of this invention to disclose the antimicrobial chemical trap or film as defined in any of the above, wherein said particles of antimicrobial substance are at least partially coated with NCC.

It is a further object of this invention to disclose the antimicrobial chemical trap or film as defined above, wherein at least a portion of said particles are disposed such that microbes contacting said upper surface will contact said particles.

It is a further object of this invention to disclose the antimicrobial chemical trap or film as defined in any of the above, wherein said particles of antimicrobial substance are at least partially coated with NCC.

It is a further object of this invention to disclose the antimicrobial chemical trap or film as defined above, wherein said film is characterized by a thickness of between 0.5 μm and 10 μm.

It is a further object of this invention to disclose the antimicrobial chemical trap or film as defined in any of the above, wherein said particles of antimicrobial substance are at least partially coated with NCC.

It is a further object of this invention to disclose the antimicrobial chemical trap or film as defined above, wherein said antimicrobial substance comprises particles selected from the group consisting of nanoparticles, microparticles, mixtures thereof, and combinations thereof.

It is a further object of this invention to disclose the antimicrobial chemical trap or film as defined in any of the above, wherein said particles of antimicrobial substance are at least partially coated with NCC.

It is a further object of this invention to disclose the antimicrobial chemical trap or film as defined in any of the above, wherein said antimicrobial substance comprises particles characterized by a median diameter of between 0.5 μm and 10 μm.

It is a further object of this invention to disclose the antimicrobial chemical trap or film as defined in any of the above, wherein said film comprises at least one additive. In some embodiments of the invention, said additive is selected from the group consisting of polymers, plasticizers, coloring agents, antioxidants, preservatives, and inert fillers.

It is a further object of this invention to disclose the antimicrobial chemical trap or film as defined in any of the above, comprising an NCC layer in contact with said lower surface, said NCC layer comprising NCC but not MgO or Mg(OH)₂. In some embodiments of the invention, said NCC layer comprises at least one additive. In some preferred embodiments of the invention, said at least one additive is selected from the group consisting of polymers, plasticizers, coloring agents, antioxidants, preservatives, and inert fillers.

It is a further object of this invention to disclose the antimicrobial chemical trap or film as defined in any of the above, comprising a thin upper NCC layer in contact with said upper surface, said thin upper NCC layer comprising NCC but not MgO or Mg(OH)_{2.}

It is a further object of this invention to disclose the antimicrobial chemical trap or film as defined in any of the above, wherein said film comprises between 1% and 50% by weight of said antimicrobial substance. In some preferred embodiments of the invention, said film comprises between 10% and 40% by weight of said antimicrobial substance. In some preferred embodiments of the invention, said film comprises between 10% and 20% by weight of said antimicrobial substance. In some preferred embodiments of the invention, said film comprises between 20% and 40% by weight of said antimicrobial substance.

In some embodiments, the NCC comprises cellulose nano-material, produced as particles (e.g., fibrils, or in other cases as crystalline material) from cellulose of various origins selected to be at least about 100 nm in length. In other embodiments, the particles are at most about 1,000 microns in length. In other embodiments, the nanoparticles are between about 100 nm and 1,000 microns in length, between about 100 nm and 900 microns in length, between about 100 nm and 600 microns in length, or between about 100 nm and 500 microns in length. In some embodiments, the NCC nanoparticles are between about 100 nm and 1,000 nm in length, between about 100 nm and 900 nm in length, between about 100 nm and 800 nm in length, between about 100 nm and 600 nm in length, between about 100 nm and 500 nm in length, between about 100 nm and 400 nm in length, between about 100 nm and 300 nm in length, or between about 100 nm and 200 nm in length.

The film disclosed herein is typically a transparent nontoxic material coat formed directly on a surface region of a substrate material or an article, or on at least one previously formed material layer disposed between the surface of the substrate or article and the film. The thickness of the film may be tailored to meet any desired property that may depend, inter alia, on the method of application, the film composition, the concentration of the antimicrobial substance, and the article of use. Typically the thickness of the film is between 0.5 μm and 10 μm. In some embodiments, the thickness is between 0.5 μm and 1 μm, between 0.5 μm and 2 μm, between 0.5 μm and 3 μm, between 0.5 μm and 4 μm, between 0.5 μm and 5 μm, between 0.5 μm and 6 μm, between 0.5 μm and 7 μm, between 0.5 μm and 8 μm, between 0.5 μm and 9 μm, between 1 μm and 10 μm, between 2 μm and 10 μm, between 3 μm and 10 μm, between 4 μm and 10 μm, between 5 μm and 10 μm, between 6 μm and 10 μm, between 7 μm and 10 μm, between 8 μm and 10 μm or between 9 μm and 10 μm.

The concentration of the antimicrobial substance (MgO or Mg(OH)₂) in the matrix material may be varied as well. In some embodiments, the film comprises between 1% and 50% (w/w) of the antimicrobial substance. In some embodiments, the film comprises (w/) between 1% and 45%, between 1% and 40%, between 1% and 35%, between 1% and 30%, between 1% and 25%, between 1% and 20%, between 1% and 15%, between 1% and 10%, between 1% and 5%, between 5% and 50%, between 10% and 50%, between 15% and 50%, between 20% and 50%, between 25% and 50%, between 30% and 50%, between 35% and 50%, between 40% and 50%, between 45% and 50%, between 10% and 45%, between 10% and 40%, between 10% and 35%, between 10% and 30%, between 10% and 25%, between 10% and 20% or between 10% and 15% of the antimicrobial substance.

In some embodiments of the invention, the antimicrobial substance (MgO and/or Mg(OH)₂) is present in the form of nanoparticles. In some embodiments of the invention, the nanoparticles are characterized by a dimension of between 1 and 10 nm, between 10 and 20 nm, between 20 and 30 nm, between 30 and 40 nm, between 40 and 50 nm, between 50 and 60 nm, between 60 and 70 nm, between 70 and 80 nm, between 80 and 90 nm, between 90 and 100 nm, between 100 and 150 nm, between 150 and 200 nm, between 250 and 300 nm, between 300 and 350 nm, between 350 and 400 nm, between 400 and 450 nm, between 450 and 500 nm, between 550 and 600 nm, between 600 and 650 nm, between 650 and 700 nm, between 700 and 750 nm, between 750 and 800 nm, between 800 and 850 nm, between 850 and 900 nm, between 900 and 950 nm, or between 950 and 999 nm.

In some embodiments of the invention, the antimicrobial substance (MgO and/or Mg(OH)₂) is present in the form of microparticles. In some embodiments, the microparticles are characterized by a dimension of between 1 and 10 μm, between 10 and 20 μm, between 20 and 30 μm, between 30 and 40 μm, between 40 and 50 μm, between 50 and 60 μm, between 60 and 70 μm, between 70 and 80 μm, between 80 and 90 μm, between 90 and 100 μm, between 100 and 150 μm, between 150 and 200 μm, between 250 and 300 μm, between 300 and 350 μm, between 350 and 400 μm, between 400 and 450 μm, or between 450 and 500 μm.

In some embodiments of the invention, the antimicrobial substance (MgO and/or Mg(OH)₂) is present in the form of a mixture and/or combination of nanoparticles and microparticles. In some embodiments, the mixture and/or combination includes nanoparticles of sizes selected from one or more of the embodiments listed above and microparticles of sizes selected from one or more of the embodiments listed above.

In some embodiments, the antimicrobial substance comprises a mixture of at least one particle or material population. As non-limiting illustrative examples, the antimicrobial substance may comprise a mixture of particles of different sizes, a mixture of MgO particles and Mg(OH)₂ particles, a mixture of MgO particles and Mg(OH)₂ particles in which the sizes and/or size distributions of the MgO particles and the Mg(OH)₂ particles differ, etc.

It is a further object of the present invention to disclose a method for producing an antimicrobial article, comprising or consisting of: (a) dispersing onto said substrate a first suspension, said first suspension comprising or consisting of nanocrystalline cellulose (NCC) and a substance selected from the group consisting of MgO, Mg(OH)₂, mixtures thereof, and combinations thereof, thereby producing an antimicrobial layer comprising an upper surface and a lower surface in which said antimicrobial substance is at least partially embedded within said antimicrobial layer; and, drying said antimicrobial layer. In preferred embodiments of the invention, the method does not include any step that involves cross-linking or the use of a cross-linking agent. In preferred embodiments of the invention, said first suspension does not include any OH-rich material. In preferred embodiments of the invention, said first suspension does not include any component that is not non-toxic.

It is a further object of the present invention to disclose such a method for producing an antimicrobial article, wherein said first suspension comprises at least one additive. In some preferred embodiments of the invention, said additive is selected from the group consisting of polymers, plasticizers, coloring agents, antioxidants, preservatives, and inert fillers.

It is a further object of the present invention to disclose such a method for producing an antimicrobial article, additionally comprising: (a) dispersing a second suspension comprising nanocrystalline cellulose (NCC) but not MgO or Mg(OH)₂ onto said substrate, thereby producing an NCC layer; and, (b) drying said NCC layer; wherein said step of dispersing said first suspension comprises dispersing said first suspension onto said NCC layer. In some preferred embodiments of the invention, at least one of said first suspension and said second suspension comprises at least one additive. In some preferred embodiments of the invention, said additive is selected from the group consisting of polymers, plasticizers, coloring agents, antioxidants, preservatives, and inert fillers. In some embodiments of the invention, said step of dispersing said first suspension is performed subsequent to said step of drying said NCC layer. In some preferred embodiments of the invention, at least one of said first suspension and said second suspension comprises between 0.1% and 3% NCC (w/v). In some preferred embodiments of the invention, each of said first suspension and said second suspension comprises between 0.1% and 15% NCC (w/v). In some preferred embodiments of the invention, each of said first suspension and said second suspension comprises between 0.1% and 6% NCC (w/v). In some preferred embodiments of the invention in which the method includes use of a second suspension, the method comprises pretreating said substrate prior to said step of dispersing said second suspension. In some preferred embodiments, said second suspension does not include any substance that is not non-toxic. In some preferred embodiments, said second suspension does not include any OH-rich material.

It is a further object of the present invention to disclose a method for producing an antimicrobial article as defined in any of the above, comprising dispersing a thin upper NCC layer on said upper surface, said thin upper NCC layer comprising NCC but not MgO or Mg(OH)₂.

It is a further object of the present invention to disclose a method for producing an antimicrobial article as defined in any of the above, wherein said substrate is not cationic.

It is a further object of the present invention to disclose a method for producing an antimicrobial article as defined in any of the above, wherein said antimicrobial substance is in the form of nanoparticles.

It is a further object of the present invention to disclose a method for producing an antimicrobial article as defined in any of the above, wherein said antimicrobial substance is in the form of microparticles.

It is a further object of the present invention to disclose a method for producing an antimicrobial article as defined in any of the above, wherein said antimicrobial substance is in the form of a mixture or combination of nanoparticles and microparticles.

It is a further object of this invention to disclose a method for producing an antimicrobial article as defined in any of the above, wherein said antimicrobial substance is in the form of a powder. In some preferred embodiments of the invention, said antimicrobial substance is in the form of a powder comprising particles selected from the group consisting of nanoparticles, microparticles, mixtures thereof, and combinations thereof.

It is a further object of the present invention to disclose a method for producing an antimicrobial article as defined in any of the above, wherein said substance selected from the group consisting of MgO and Mg(OH)₂ comprises particles having a median diameter of 1 and 10 μm.

It is a further object of the present invention to disclose a method for producing an antimicrobial article as defined in any of the above, wherein said first suspension comprises between 0.1% and 15% NCC (w/v).

It is a further object of the present invention to disclose a method for producing an antimicrobial article as defined in any of the above, wherein said first suspension comprises said antimicrobial substance and NCC in a ratio of between 1:100 and 50:100 (w/w). In some preferred embodiments of the invention, said first suspension comprises said antimicrobial substance and NCC in a ratio of between 10:100 and 40:100 (w/w). In some preferred embodiments of the invention, said first suspension comprises said antimicrobial substance and NCC in a ratio of between 10:100 and 20:100 (w/w). In some preferred embodiments of the invention, said first suspension comprises said antimicrobial substance and NCC in a ratio of between 20:100 and 40:100 (w/w).

It is a further object of the present invention to disclose a method for producing an antimicrobial article as defined in any of the above, wherein said first suspension comprises between 1% and 2% NCC (w/v), and said antimicrobial substance and said NCC are in a ratio of between 10:100 and 20:100 (w/w).

It is a further object of the present invention to disclose a method for producing an antimicrobial article as defined in any of the above, comprising pretreating said substrate prior to said step of dispersing said first suspension.

It is a further object of the present invention to disclose a method for producing an antimicrobial article as defined in any of the above, wherein said antimicrobial substance is not located between said antimicrobial layer and said substrate.

It is a further object of the present invention to disclose a method for producing an antimicrobial article as defined in any of the above, wherein said substrate is selected from the group consisting of glass, polymers, hybrid materials, biomaterials, dielectric materials, fibers, paper, cardboard, metal surfaces, cement, concrete, plaster, wood, food surfaces, and any combination of the above.

It is a further object of the present invention to disclose a method for producing an antimicrobial article as defined in any of the above, wherein said step of dispersing comprises dispersing said first suspension so as to produce an antimicrobial layer having a thickness of between 0.5 and 10 μm. In some preferred embodiments of the invention in which the method includes use of a second suspension, said step of dispersing comprises dispersing said second suspension so as to produce an NCC layer having a thickness of between 0.5 and 10 μm.

It is a further object of this invention to disclose a method for applying an antimicrobial coating to a substrate, comprising: (a) dispersing onto said substrate a first suspension, said first suspension comprising nanocrystalline cellulose (NCC) and a substance selected from the group consisting of MgO and Mg(OH)₂, thereby producing an antimicrobial layer; and, (b) drying said antimicrobial layer. In preferred embodiments of the invention, said first suspension does not include any OH-rich material. In preferred embodiments of the invention, the method does not include any step of cross-linking. In some embodiments of the invention, said first suspension comprises at least one additive. In some embodiments of the invention, said additive is selected from the group consisting of polymers, plasticizers, coloring agents, antioxidants, preservatives, and inert fillers.

It is a further object of this invention to disclose such a method for applying an antimicrobial coating to a substrate, wherein said step of dispersing is preceded by: (a) dispersing onto said substrate a second suspension comprising NCC, thereby producing an NCC layer; and, (b) drying said NCC layer. In some preferred embodiments of the invention, the method comprises a step of pretreating the substrate prior to the step of dispersing said second suspension onto said substrate. In some preferred embodiments of the invention, said step of dispersing said second suspension comprises dispersing said second suspension so as to produce an NCC layer having a thickness of between 0.5 and 10 μm. In some embodiments of the invention, said second suspension comprises at least one additive. In some embodiments of the invention, said at least one additive is selected from the group consisting of polymers, plasticizers, coloring agents, antioxidants, preservatives, and inert fillers.

It is a further object of this invention to disclose a method for applying an antimicrobial coating to a substrate as defined in any of the above, wherein said substrate is not cationic.

It is a further object of this invention to disclose a method for applying an antimicrobial coating to a substrate as defined in any of the above, wherein said substance selected from the group consisting of MgO and Mg(OH)₂ is in the form of a powder. In some preferred embodiments of the invention, said substance selected from the group consisting of MgO and Mg(OH)₂ is in the form of a powder comprising particles selected from the group consisting of nanoparticles and microparticles.

It is a further object of this invention to disclose a method for applying an antimicrobial coating to a substrate as defined in any of the above, wherein said first suspension comprises between 0.1% and 3% NCC (w/v). In some preferred embodiments of those embodiments of the method in which it includes dispersing a second suspension, each of said first suspension and said second suspension comprises between 0.1% and 3% NCC (w/v).

It is a further object of this invention to disclose a method for applying an antimicrobial coating to a substrate as defined in any of the above, wherein said first suspension comprises said substance and NCC in a ratio of between 1:100 and 50:100 (w/w). In some preferred embodiments of the method, said first suspension comprises said substance and NCC in a ratio of between 10:100 and 40:100 (w/w). In some preferred embodiments of the method, said first suspension comprises said substance and NCC in a ratio of between 10:100 and 20:100 (w/w). In some preferred embodiments of the method, said first suspension comprises said substance and NCC in a ratio of between 20:100 and 40:100 (w/w).

It is a further object of this invention to disclose a method for applying an antimicrobial coating to a substrate as defined in any of the above, comprising pretreating said substrate prior to said step of dispersing said first suspension.

It is a further object of this invention to disclose a method for applying an antimicrobial coating to a substrate as defined in any of the above, wherein said substrate is selected from the group consisting of glass, polymers, hybrid materials, biomaterials, dielectric materials, fibers, paper, cardboard, metal surfaces, cement, concrete, plaster, wood, food surfaces, and any combination of the above.

It is a further object of this invention to disclose a method for applying an antimicrobial coating to a substrate as defined in any of the above, wherein said step of dispersing comprises dispersing said first suspension so as to produce an antimicrobial layer having a thickness of between 0.5 and 10 μm.

It is a further object of this invention to disclose a method for applying an antimicrobial chemical trap to a substrate, comprising: dispersing onto said substrate a first suspension, said first suspension comprising or consisting of nanocrystalline cellulose (NCC) and an antimicrobial substance selected from the group consisting of MgO, Mg(OH)₂, mixtures thereof, and combinations thereof, thereby producing an antimicrobial chemical trap comprising an antimicrobial layer; and, drying said antimicrobial layer. In preferred embodiments of the invention, it does not include any step comprising cross-linking. In preferred embodiments of the invention, said first suspension does not comprise any OH-rich material. In preferred embodiments of the invention, said first suspension does not comprise any component that is not non-toxic.

It is a further object of this invention to disclose such a method for applying an antimicrobial chemical trap to a substrate, wherein said step of dispersing is preceded by: dispersing onto said substrate a second suspension comprising NCC but not MgO or Mg(OH)₂, thereby producing an NCC layer; and, drying said NCC layer. In some preferred embodiments, at least one of said first suspension and said second suspension comprises between 0.1% and 3% NCC (w/v).

It is a further object of this invention to disclose a method for applying an antimicrobial chemical trap to a substrate as defined in any of the above, wherein said antimicrobial substance is in a form selected from the group consisting of nanoparticles, microparticles, mixtures thereof, and combinations thereof. In some preferred embodiments of the invention, said antimicrobial substance comprises or consists of particles having a median diameter of between 0.5 μm and 10 μm.

It is a further object of this invention to disclose a method for applying an antimicrobial chemical trap to a substrate as defined in any of the above, wherein said first suspension comprises at least one additive. In some preferred embodiments of the invention, said additive is selected from the group consisting of polymers, plasticizers, coloring agents, antioxidants, preservatives, and inert fillers. In some embodiments of the invention in which the method comprises use of a second suspension, at least one of said first suspension and said second suspension comprises at least one additive. In some embodiments of the invention in which the method comprises use of a second suspension, at least one of said first suspension and said second suspension comprises at least one additive selected from the group consisting of polymers, plasticizers, coloring agents, antioxidants, preservatives, and inert fillers.

It is a further object of this invention to disclose a method for applying an antimicrobial chemical trap to a substrate as defined in any of the above, wherein said substrate is not cationic.

It is a further object of this invention to disclose a method for applying an antimicrobial chemical trap to a substrate as defined in any of the above, wherein said first suspension comprises between 0.1% and 15% NCC (w/v). In some preferred embodiments of the invention, said first suspension comprises between 0.1% and 6% NCC (w/v). In some preferred embodiments of the invention, said first suspension comprises between 0.1% and 3% NCC (w/v).

It is a further object of this invention to disclose a method for applying an antimicrobial chemical trap to a substrate as defined in any of the above, wherein said first suspension comprises said antimicrobial substance and NCC in a ratio of between 1:100 and 50:100 (w/w). In some preferred embodiments, said first suspension comprises said antimicrobial substance and NCC in a ratio of between 10:100 and 40:100 (w/w). In some preferred embodiments, said first suspension comprises said antimicrobial substance and NCC in a ratio of between 10:100 and 20:100 (w/w). In some preferred embodiments, said first suspension comprises said antimicrobial substance and NCC in a ratio of between 20:100 and 40:100 (w/w). In some especially preferred embodiments, said first suspension comprises between 1% and 2% NCC (w/v), and said first substance and said NCC in a ratio of between 10:100 and 20:100 (w/v).

It is a further object of this invention to disclose a method for applying an antimicrobial chemical trap to a substrate as defined in any of the above, comprising pretreating said substrate prior to said step of dispersing said first suspension.

It is a further object of this invention to disclose a method for applying an antimicrobial chemical trap to a substrate as defined in any of the above, wherein said substrate is selected from the group consisting of glass, polymers, hybrid materials, biomaterials, dielectric materials, fibers, paper, cardboard, metal surfaces, cement, concrete, plaster, wood, food surfaces, and any combination of the above.

It is a further object of this invention to disclose a method for applying an antimicrobial chemical trap to a substrate as defined in any of the above, wherein said step of dispersing comprises dispersing said first suspension so as to produce an antimicrobial layer having a thickness of between 0.5 and 10 μm.

It is a further object of this invention to disclose a method for applying an antimicrobial chemical trap to a substrate as defined in any of the above, wherein said method does not include any step of dispersing said antimicrobial substance between said antimicrobial layer and said substrate.

It is a further object of this invention to disclose an article comprising an antimicrobial coating, said article comprising: (a) a substrate; and, (b) an antimicrobial chemical trap comprising a film comprising or consisting of an antimicrobial layer characterized by an upper surface and lower surface, said antimicrobial chemical trap comprising nanocrystalline cellulose (NCC) and an antimicrobial substance selected from the group consisting of MgO, Mg(OH)₂, mixtures thereof, and combinations thereof embedded within said film, said film disposed on at least one surface of said substrate such that said lower surface is in contact with said substrate. In preferred embodiments of the invention, said antimicrobial coating does not comprise and OH-rich material. In preferred embodiments of the invention, said antimicrobial coating does not comprise any cross-linking agent or catalyst or any substance that is the product of a cross-linking reaction. In preferred embodiments of the invention, said antimicrobial coating does not comprise any component that is not non-toxic.

It is a further object of this invention to disclose such an article comprising an antimicrobial coating, wherein said antimicrobial layer comprises at least one additive. In preferred embodiments of the invention, said additive is selected from the group consisting of polymers, plasticizers, coloring agents, antioxidants, preservatives, and inert fillers.

It is a further object of this invention to disclose an article comprising an antimicrobial coating as defined in any of the above, wherein said antimicrobial chemical trap comprises an NCC layer comprising NCC but not MgO or Mg(OH)₂ disposed between said substrate and said antimicrobial layer. In some preferred embodiments of the invention, said NCC layer has a thickness of between 0.5 μm and 10 μm. In some embodiments of the invention, said NCC layer comprises at least one additive. In preferred embodiments of the invention, said NCC layer comprises at least one additive selected from the group consisting of polymers, plasticizers, coloring agents, antioxidants, preservatives, and inert fillers.

It is a further object of this invention to disclose an article comprising an antimicrobial coating as defined in any of the above, wherein said antimicrobial substance is in a form selected from the group consisting of nanoparticles, microparticles, mixtures thereof, and combinations thereof. In some preferred embodiments of the invention, said antimicrobial substance comprises or consists of particles having a median diameter of between 0.5 μm and 10 μm.

It is a further object of this invention to disclose an article comprising an antimicrobial coating as defined in any of the above, wherein said film comprises between 1% and 50% by weight of said antimicrobial substance. In some preferred embodiments of the invention, said film comprises between 1% and 15% by weight of said antimicrobial substance. In some preferred embodiments of the invention, said film comprises between 10% and 40% by weight of said antimicrobial substance. In some preferred embodiments of the invention, said film comprises between 10% and 20% by weight of said antimicrobial substance. In some preferred embodiments of the invention, said film comprises between 20% and 40% by weight of said antimicrobial substance.

It is a further object of this invention to disclose an article comprising an antimicrobial coating as defined in any of the above, wherein said antimicrobial chemical trap comprises a thin upper NCC layer comprising NCC but not MgO or Mg(OH)₂ disposed on said upper surface.

It is a further object of this invention to disclose an article comprising an antimicrobial coating as defined in any of the above, wherein said substrate is not cationic.

It is a further object of this invention to disclose an article comprising an antimicrobial coating as defined in any of the above, wherein said substrate is selected from the group consisting of glass, polymers, hybrid materials, biomaterials, dielectric materials, fibers, paper, cardboard, metal surfaces, cement, concrete, plaster, wood, food surfaces, and any combination of the above.

It is a further object of this invention to disclose an article comprising an antimicrobial coating as defined in any of the above, wherein said substrate comprises at least one surface that has been pretreated to induce, permit, or hasten association of said surface and said layer.

It is a further object of this invention to disclose an article comprising an antimicrobial coating as defined in any of the above, wherein said antimicrobial layer is characterized by a thickness of between 0.5 μm and 10 μm.

It is a further object of this invention to disclose an article comprising an antimicrobial coating as defined in any of the above, produced according to the method of producing an article with an antimicrobial coating as defined in any of the above.

It is a further object of this invention to disclose an article comprising an antimicrobial coating as defined in any of the above, wherein said article is selected from the group consisting of cloth, packaging, containers, products for wrapping and containing food, coatings for walls, coatings for work surfaces, coatings for shelves, and coatings for countertops.

It is a further object of this invention to disclose an article comprising a substrate coated by an antimicrobial coating, wherein said antimicrobial coating is applied to said substrate according to the method as defined in any of the above.

It is a further object of this invention to disclose a method of controlling a microbial population, wherein said method comprises: obtaining an antimicrobial chemical trap or film as defined in any of the above; and, exposing a population of microbes to said upper surface of said antimicrobial trap, thereby exposing said microbes to antimicrobial activity arising from said antimicrobial substance. In some embodiments of the invention, said method comprises controlling a population of at least one type of microbe selected from the group consisting of E. coli, S. aureus, P. aeruginosa, Salmonella, and Listeria.

It is a further object of this invention to disclose a method of controlling a microbial population, comprising exposing a population of microbes to said antimicrobial layer or chemical antimicrobial trap of an article as defined in any of the above. In preferred embodiments of the invention, said method comprises exposing said population to said antimicrobial layer until said population has decreased by a predetermined amount. In some embodiments of the invention, said step of exposing said population of microbes to said antimicrobial layer comprises exposing said population of microbes to said antimicrobial layer until said population has decreased by at least two orders of magnitude. In some embodiments of the invention, said step of exposing said population of microbes to said antimicrobial layer comprises exposing said population of microbes to said antimicrobial layer until said population has decreased by at least three orders of magnitude. In some embodiments of the invention, said step of exposing said population of microbes to said antimicrobial layer comprises exposing said population of microbes to said antimicrobial layer until said population has decreased by at least four orders of magnitude. In some embodiments of the invention, said step of exposing comprises exposing a population comprising at least one type of microbe selected from the group consisting of E. coli, S. aureus, P. aeruginosa, Salmonella, and Listeria.

It is a further object of this invention to disclose a method for controlling a microbial population, comprising: dispersing onto a substrate a first suspension, said first suspension comprising nanocrystalline cellulose (NCC) and an antimicrobial substance selected from the group consisting of MgO, Mg(OH)₂, mixtures thereof, and combinations thereof, thereby producing an antimicrobial layer characterized by an upper surface and a lower surface, such that said antimicrobial substance is disposed in sufficient proximity to said upper surface such that microbes impinging on said upper surface will be exposed to antimicrobial activity by said antimicrobial substance; drying said antimicrobial layer; and, placing said antimicrobial layer in a location such that said upper surface is accessible to microbes. In some embodiments, the method additionally comprises: dispersing a second suspension comprising nanocrystalline cellulose (NCC) but not MgO or Mg(OH)₂ onto said substrate, thereby producing an NCC layer; and, drying said NCC layer; wherein said step of dispersing said first suspension comprises dispersing said first suspension onto said NCC layer. In some preferred embodiments of the method, it comprises exposing a population of microbes to said antimicrobial layer.

It is a further object of this invention to disclose a method for controlling a microbial population, comprising exposing a population of microbes to said antimicrobial layer of the article as defined in any of the above until said population has decreased by a predetermined amount.

### BRIEF DESCRIPTION OF THE FIGURES

The invention will now be described with reference to the figures, wherein:

FIG. 1 presents an SEM picture of an unmodified NCC surface;

FIGS. 2A and 2B present SEM pictures and an EDS analysis, respectively, of an MgO/NCC surface;

FIGS. 3A and 3B present SEM pictures and an EDS analysis, respectively, of a nanoparticulate MgO/NCC surface; and,

FIGS. 4A, 4B, and 4C present an SEM picture and an EDS analysis of an MgO/NCC surface comprising MgO particles with a median diameter of 2.36 μm, and an SEM picture of a control NCC surface, respectively.

### DETAILED DESCRIPTION OF THE PREFERRED EMBODIMENTS

In the following description, various aspects of the invention will be described. For purposes of explanation and illustration, specific details are set forth in order to provide a thorough understanding of the invention disclosed herein and to assist a person having ordinary skill in the art in the making and using thereof. The specific details provided in the specification and examples are therefore not to be considered to limit the scope of the invention. It will be apparent to one skilled in the art that there are other embodiments of the invention that differ in details without affecting the essential nature thereof; all such embodiments are considered by the inventors to be within the scope of the invention. Furthermore, listings of specific combinations of elements are not intended to be limiting. Any combination of elements disclosed herein that is not self-contradictory is considered by the inventors to be within the scope of the invention.

Unless stated otherwise, any numerical range recited herein is understood to be inclusive, i.e. to include the values given as upper and lower limits of the range.

As used herein, the abbreviations “NCC” and “CNC” are used synonymously to represent the expression “nanocrystalline cellulose.”

As used herein, the abbreviation “MgO/NCC” refers to the composition disclosed herein or to a product of the method disclosed herein, without regard to the exact chemical nature of the magnesium-containing component of the product. As a non-limiting example, in some non-limiting embodiments of the invention, a composition described as being “MgO/NCC” may contain Mg(OH)₂ in addition to or instead of MgO, as explained in detail below.

As used herein, the term “antimicrobial chemical trap” is used to describe a material that shows significant antimicrobial activity and that comprises particles of an antimicrobial substance immobilized in or on a polymeric matrix.

As used herein, the abbreviation “BOPP” represents the expression “biaxially oriented polypropylene.”

As used herein, the term “OH-rich material” is used to refer to organic compounds having three or more —OH groups.

As used herein, the term “nanoparticle” refers to a particle having a dimension of at least one 1 nm and less than 1000 nm, where “dimension” refers to the diameter in the case of a spherical particle and the effective diameter in the case of a non-spherical particle.

As used herein, the term “microparticle” refers to a particle having a dimension of between 1 μm and 1000 μm, where “dimension” refers to the diameter in the case of a spherical particle and the effective diameter in the case of a non-spherical particle.

As used herein, when a particulate material is described as being “embedded” in a matrix, the term “embedded” is used to describe a particle that is least partially below the surface of the matrix sufficiently to be immobilized within the matrix. Under this definition, an “embedded” particle may be completely within the matrix, or partially within the matrix and partially above the surface of the matrix.

As used herein, the term “nontoxic” is used to refer to a substance that has a reported LD₅₀ for ingestion or dermal contact of greater than 1 g/kg body weight.

The invention disclosed herein provides an improved method for preparing an antimicrobial coating or film; an improved method for preparing an antimicrobial article that comprises a substrate coated by an antimicrobial coating; a novel antimicrobial film that can be used as a coating for a variety of substrates; a “chemical trap” comprising the novel antimicrobial film; antimicrobial articles that comprise a substrate onto which an antimicrobial coating has been applied; and a method for controlling microbial populations. In all cases, the antimicrobial coating includes as an active ingredient MgO, Mg(OH)₂ or a mixture or combination of the two. In preferred embodiments, no active antimicrobial substance other than MgO or Mg(OH)₂ is used in the preparation of the invention.

For the sake of simplicity, in the following description, embodiments of the invention in which the active ingredient is MgO are described, but it is understood that in all cases, the MgO can be partially or entirely replaced by an equimolar quantity of Mg(OH)₂. The Mg(OH)₂ may be present, for example, as a product of incidental reaction between water and MgO, as a product of a purposefully induced reaction between water and MgO, or as a separate component added as such.

The MgO/NCC films of the present invention comprise an antibacterial layer comprising an NCC film, typically having a thickness of between 0.5 μm and 10 μm, and MgO particles dispersed on or within the NCC film. In preferred embodiments of the invention, the NCC is characterized by crystal dimensions of 5-50 nm width and 150-500 nm length. In some embodiments of the invention, the antibacterial layer comprises nanoparticulate MgO. The inventors have discovered, surprisingly, that in many cases, the antibacterial activity of films comprising MgO particles having median diameters of 1-10 μm is at least as great or even greater than that of films containing nanoparticulate MgO. Examples of the antibacterial activity of some exemplary non-limiting embodiments of the invention are given below. Thus, in some preferred embodiments of the embodiments of the invention, the antibacterial layer contains microparticulate MgO. In preferred embodiments of the invention, the film does not comprise any antimicrobial substance other than MgO. In preferred embodiments of the invention, the MgO particles are homogeneously dispersed in or on the film. That is, the number of MgO particles per unit area of film will be approximately the same for any given part of the film.

In some embodiments of the invention, the film additionally comprises an NCC layer that does not have any MgO below the antibacterial layer. For some substrates, it is found that embodiments containing this NCC layer adhere more effectively to the substrate than embodiments lacking it.

In some embodiments of the invention, the film additionally comprises a thin upper NCC layer applied above the antimicrobial layer. In preferred embodiments of the invention, the thin upper NCC layer has a thickness of less than 1 μm. In the most preferred embodiments of the invention, the thin upper NCC layer has a thickness of about 100 nm. The thin upper layer serves to coat the MgO particles, but leaves them close enough to the surface that microbes can interact with them, e.g. after consuming the cellulose and thereby coming into contact with the MgO particles or the antimicrobial substances produced in the vicinity of the MgO particles.

In contrast to oxide/NCC films known in the art, in the films of the present invention, the MgO particles are not located between the NCC film and the substrate. Rather, they are located at or near the upper surface of the film (i.e. the surface not in contact with the substrate). As shown below, it is not necessary for the surface of the MgO particles to be exposed directly to the environment, as a thin layer of NCC on the MgO particles does not eliminate their antibacterial activity. Furthermore, it is reasonable to expect that the procedure for preparation of the MgO/NCC film described below will coat the MgO particles at least partially with a layer of NCC.

The inventors have found, surprisingly, that in contrast to analogous materials known in the art, it is possible to prepare useful MgO/NCC films or coatings that contain as much as 50% by weight MgO relative to the weight of the NCC. In preferred embodiments of the invention, the film contains 1-50% MgO by weight relative to the weight of the NCC. In more preferred embodiments of the invention, the film contains 10-40% MgO by weight relative to the weight of the NCC. In the most preferred embodiments of the invention, the film contains 10-20% MgO by weight relative to the weight of the NCC.

Exemplary non-limiting embodiments of methods of preparation of the antimicrobial film of the invention herein disclosed and of articles coated by the antimicrobial film are now described. These methods of preparation are considered by the inventors to be within the scope of the invention herein disclosed.

A suspension comprising NCC and MgO is prepared. In preferred embodiments, the MgO is in the form of a powder, preferably one comprising nanoparticles or microparticles. The inventors have found, surprisingly, that MgO/NCC materials containing microparticulate MgO are at least as effective for controlling microbial populations as are MgO/NCC materials containing nanoparticulate MgO, and in many cases, the microparticle-containing materials are actually more effective than the nanoparticle-containing materials.

The inventors have found, surprisingly, that in contrast to analogous materials known in the art, it is possible to prepare useful MgO/NCC films or coatings that contain as much as 50% by weight MgO relative to the weight of the NCC. In typical embodiments of the instant invention, the NCC comprises crystals characterized by a width of 5-50 nm and a length of 150-500 nm. In typical embodiments, the NCC concentration in the suspension is 0.1-3% (w/v), and the MgO:NCC ratio is between 1:100 and 50:100 (w/w). In some preferred embodiments of the invention, the MgO:NCC ratio is between 10:100 and 40:100 (w/w). In some particularly preferred embodiments of the invention, the MgO:NCC ratio is 10:100 (w/w). In other particularly preferred embodiments of the invention, the MgO:NCC ratio is 20:100 (w/w).

The suspension can be prepared by any method known in the art; a non-limiting example is sonication. In these embodiments, the mixture is sonicated, typically for a few minutes, until a homogeneous suspension is obtained.

The suspension is then dispersed on at least one surface of a substrate to form a film. The suspension can be dispersed on the substrate by any method known in the art that will produce a film of the desired thickness, typically between 0.5 and 10 μm. Sheets of thickness greater than 10 μm can also be produced by this method. The exact thickness of the coating produced (e.g. a coating of thickness <10 μm or a sheet of thickness ≥10 μm) will depend on the specific use for which the final product is intended. Non-limiting examples of procedures that can be used to disperse the coating on the substrate include use of a rod coater or commercially available paper or plastic coating instruments, or by wetting, brushing, dipping, roll coating, R2R, S2S, or any other method known in the art for forming a film on a solid surface.

It is well-known in the art that MgO reacts with water to form Mg(OH)₂. Depending on such factors as the time between preparation of the suspension and its dispersion on the substrate, the size of the particles, etc., some or all of the MgO added to the suspension may have reacted with the water to form Mg(OH)₂ before the suspension is dispersed on the substrate. While in preferred embodiments of the method of preparation of the antimicrobial film, the suspension is prepared using MgO, any product made by the method is considered by the inventors to be within the scope of the invention, without regard to the exact identity of the magnesium-containing component contained therein.

Following dispersion of the suspension on the substrate, the film is then dried. The conditions for drying the film will depend on the specific substrate, as will be appreciated by one of ordinary skill in the art. The drying is typically performed in air at room temperature. In some embodiments, the drying is performed at elevated temperature, typically between room temperature and 220° C.; the optimal drying temperature depends on the surface.

In some embodiments, coating of the substrate to form an MgO/NCC film is preceded by coating with an NCC film. In these embodiments, a suspension of NCC (i.e. one that does not contain MgO) is prepared as described above, dispersed on the surface of the substrate, and dried to form an NCC layer, which is then dried as described above. The antimicrobial MgO/NCC layer is then prepared as described above except that the antimicrobial layer is dispersed on the NCC layer rather than directly onto the surface of the substrate. The inventors have found that the NCC/MgO layer tends to adhere better to the NCC layer than to the surface of the substrate, and hence, providing a first NCC layer onto which the NCC/MgO antimicrobial layer is coated yields a more active and more stable final product.

Any substrate onto which the coating will form a stable film may be used. Non-limiting examples include glass, polymers, hybrid materials, biomaterials, dielectric materials, fibers, paper, cardboard, metal surfaces, cement, concrete, plaster, wood, and food surfaces. Non-limiting examples of food surfaces that can act as a substrate include freshly cut fruits and vegetables. Non-limiting examples of polymers that can serve as substrates include polyethylene (PE), biaxially oriented polypropylene (BOPP), and polyethylene terephthalate (PET). Non-limiting examples of fibers that can serve as substrates include cotton fibers and glass fibers. The inventors note that in contrast to similar articles known in the prior art in which a cationic surface is required for electrostatic attachment of the negatively charged NCC layer, the instant invention does not require that the NCC/MgO coating be placed on a positively charged surface. In fact, in the instant invention, the surface to be coated is preferably not cationic. Without being bound by theory, it appears that in the instant composition, the MgO neutralizes the NCC layer, obviating any necessity for a cationic surface.

In some embodiments, the surface of the substrate is pretreated in order to strengthen or accelerate the binding of the film to the substrate. Any appropriate pretreatment method known in the art may be used. Non-limiting examples include washing of the surface, etching, heating, plasma treatment, UV/ozone treatment, corona discharge, laser, flashlamp, or microwave irradiation, coating by a protective or primer layer, or any combination thereof.

It is further emphasized that in contrast to MgO-impregnated fibers and sheets known in the art, the instant invention yields MgO/NCC coatings and sheets in which the MgO remains exposed and available on the surface and thus capable of interacting with and killing microorganisms that approach or touch the surface. It is also emphasized that, in contrast to compositions known in the art that comprise an NCC film containing nanoparticles, in the films and coatings of the invention herein disclosed, the MgO particles are located primarily at or near the upper surface of the film (i.e. the surface that is not in contact with the substrate or with the layer in contact with the substrate) rather than between the NCC film and the substrate. In preferred embodiments of the invention herein disclosed, the MgO is at least partially exposed at or on the upper surface of the film or coating.

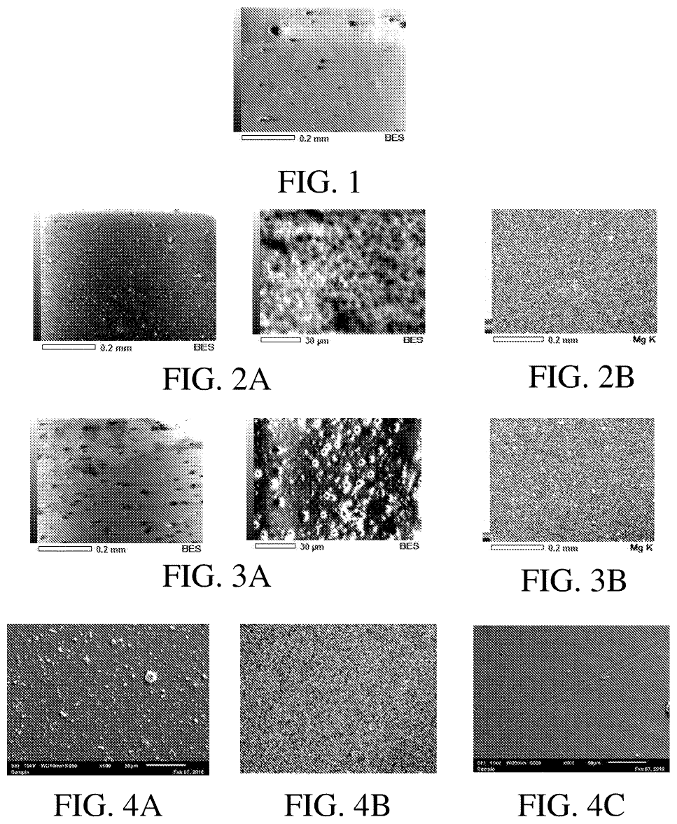

Reference is now made to FIGS. 1-3, which present non-limiting examples of experimental characterizations of some MgO/NCC surfaces prepared according to the method disclosed herein. FIG. 1 shows an SEM picture of an unmodified NCC surface. FIG. 2 shows SEM pictures (2A) and an EDS analysis (2B) of an MgO/NCC surface of the present invention in which the MgO/NCC suspension was prepared by using Special Industrial Grade (SIG) MgO (periclase), specified as ≥99.0% MgO and characterized by d₉₀ of 39.7 μm; d₅₀ of 16.5 μm; and d₁₀ of 3.8 μm. FIG. 3 shows SEM pictures (3A) and an EDS analysis (3B) of an MgO/NCC surface of the present invention in which the MgO/NCC suspension was prepared by using microparticulate MgO. Table 1 presents a summary of experimental characterizations of the microparticulate MgO that was used in the MgO/NCC suspension from which the surface shown in FIG. 3 was prepared.

TABLE 1

| Parameter | Value | |
|---|---|---|
| Bulk Density | 0.43 | g/cc |
| D₅₀ | 5.9 | μm |
| D₉₀ | 43.5 | μm |
| surface area | 8.4 | g/m² |

Thus, the single inventive process disclosed herein can be used to provide an antimicrobial coating to a wide variety of different articles such as cloth, packaging, containers, products for wrapping and containing food, exposed surfaces of food such as freshly-cut fruits and vegetables, coatings and topcoats for walls, work surfaces, shelves, countertops (e.g. in food preparation areas such as kitchens), etc., and as a means of producing such articles with nontoxic antimicrobial surfaces.

In some embodiments of the invention, the material acts as a “chemical trap” for microbes. The NCC acts to enhance the adherence of microbes to the surface and/or serves a material that by itself (i.e. in the absence of MgO) can enable an increase in the microbial population thereupon. The microbes are killed by contact with MgO or antimicrobial chemicals (e.g. peroxides) produced via chemical reaction of MgO or catalyzed by the MgO, as discussed above. Thus, without being bound by theory, it appears that the MgO need not be completely exposed on the upper surface of the coating or film, but only need be sufficiently close to the surface that the microbial population will consume at least partially any NCC coating the MgO particles, thereby contacting the particles or anti-microbial substances produced in the vicinity of the particles. The NCC and MgO thus provide a synergistic combination: the NCC is a good medium for the bacteria and thereby actually promotes contact between the bacteria and the medium that is used to control their population.

In addition to the synergy between the NCC and the MgO, another advantage of the invention herein disclosed is that it is made of nontoxic materials. The inertness and low toxicity of MgO is well known in the art, the LD50 being on the order of 1 g/kg body weight. Indeed, MgO is used for example as an excipient for pills. NCC is also believed to nontoxic upon ingestion or skin contact (Roman, M.; “Toxicity of Cellulose Nanocrystals: A Review”; Ind. Biotechnology 2015, 11, 25; doi: 10.1089/ind.2014.0024).

The following examples are presented to assist a person of ordinary skill in the art to make and use the invention disclosed herein. They are not to be construed as limiting in any way.

### EXAMPLE 1

40 ml of a 2% NCC suspension (w/v) was sonicated for 1 min using a probe sonicator in order to obtain a homogeneous suspension. The suspension was applied using a rod coater onto a corona treated 30 μm thick BOPP film. The coating was dried at room temperature to yield a 1 μm thick NCC coating.

40 mg of MgO powder was added to 40 ml of a 2% NCC suspension, corresponding to an MgO:NCC ratio of 0.1% w/w. The suspension was sonicated for 1 min by using a probe sonicator in order to obtain a homogeneous suspension. The suspension was applied onto the dry NCC coating by using a rod coater. The MgO/NCC coating was dried at room temperature.

### EXAMPLE 2

Coated BOPP films were prepared as described in the preceding example except that the MgO:NCC ratio was 10% w/w. A control sample was prepared in which the coating comprised NCC but no MgO. Experimental samples were then prepared according to the method described in the previous example, in which the antimicrobial coating contained either MgO (periclase) powder or MgO nanoparticles. Samples of E. coli (type culture ATCC 8739) were obtained from the American Type Culture Collection (ATCC) in lyophilized form and refreshed according to the ATCC-specified procedure. Bacterial stocks were prepared and maintained in a Pro-Lab Diagnostic Microbank system at a temperature of between −70° C. and −80° C. The bacteria were refreshed and grown on Tryptic Soy Agar at a temperature of 37±2° C. The bacteria were exposed to 50 mm×50 mm control and experimental samples, and the antibacterial activity of the MgO/NCC coating determined according to the standard JIS Z 2801:2000 test procedure as follows.

The bacteria were separately suspended in nutrient broth (1/500) and diluted to a concentration of 2.5-10×10⁵ cells/ml. 0.2 ml of the inoculum was then placed on each tested surface and the inoculum was covered with a thin glass cover plate. The inoculated test surfaces were placed in an incubator for 24 h at 35° C. and a relative humidity of 90%. After completion of the incubation period, the tested surfaces were put into a stomacher (1 minute for each surface) pouch containing SCDLP broth (10 ml). Then, 1 ml of the SCDLP solution was added into a Universal Neutralizer solution (9 ml) for E. coli, and a modified Universal Neutralizer solution (10 ml) for Staphylococcus aureus. After completion of the washing, the bacteria present in the wash liquid were spread on PCA plates and incubated at 35° C. for 48 hours.

The bacterial concentrations were measured at T₀ (i.e. at the time of exposure of the surface to the bacteria) and after 24 hours. The results are summarized in Table 2.

TABLE 2

| | Bacterial | Bacterial | | Average |
|---|---|---|---|---|
| | count (T₀) | count (24 h) | Log | log |
| Sample | CFU/ml | CFU/ml | reduction | reduction |
| NCC | 8.05 × 10⁵ | 5.90 × 10⁸ | — | — |
| no MgO | 6.25 × 10⁵ | 3.15 × 10⁸ | | |
| | 7.50 × 10⁵ | 4.65 × 10⁸ | | |
| NCC + MgO | — | 2.75 × 10⁶ | 2.2 | 3.6 |
| periclase (10%) | — | 5.50 × 10² | 5.9 | |
| | — | 1.09 × 10⁶ | 2.6 | |
| NCC + | — | 1.65 × 10⁷ | 1.4 | 2.2 |
| nanoparticulate | — | 4.45 × 10⁷ | 1.0 | |
| MgO Mg(OH)₂ | — | 2.85 × 10⁴ | 4.2 | |
| (10%) | | | | |

As summarized in the table, significant reduction in the bacterial populations exposed to surfaces containing MgO relative to those not containing MgO was observed within 24 hours of the exposure of the bacteria to the anti-microbial coating of the present invention, with reductions in the bacterial population of 2-4 orders of magnitude. The results indicate that, surprisingly, the coating of the instant invention containing normal periclase MgO powder is actually more effective at controlling the population of E. coli than is a coating containing nanoparticulate MgO.

Without wishing to be bound by theory, it appears that the variation in antimicrobial activity from sample to sample is due to non-uniform distribution of the MgO particles in the antimicrobial coating.

### EXAMPLE 3

Control and experimental coated BOPP films were prepared as described in the preceding example. The coated BOPP films were then exposed to Staphyloccocus aureus (culture type ATCC 6538, obtained from the American Type Culture Collection) and the antibacterial activity of the MgO/NCC coating determined according to the standard JIS Z 2801:2000 test procedure as described above for E. coli. The results are summarized in Table 3.

TABLE 3

| | Bacterial | Bacterial | |
|---|---|---|---|
| | count (T₀) | count (24 h) | Log |
| Sample | CFU/ml | CFU/ml | reduction |
| NCC | 1.5 × 10⁷ | 1.7 × 10⁸ | — |
| no MgO | | | |
| NCC + MgO | — | 1.97 × 10³ | 5.3 |
| (10%) | | | |
| NCC + | — | 6.00 × 10³ | 4.8 |
| nanoparticulate | | | |
| Mg(OH)₂ (10%) | | | |

As can be seen from the results, the films containing MgO showed significantly greater antimicrobial activity than did the NCC film. In this case, the bacterial population was reduced by ˜5 orders of magnitude relative to its growth on untreated NCC.

### EXAMPLE 4

As a test of the effect of varying the magnesium-containing component of the MgO/NCC films of the instant invention, a comparison was made of the efficacy of BOPP films prepared as described above containing either 10% “light” MgO (periclase), 10% MgO (periclase) or 10% magnesium peroxide against Staphylococcus aureus ATCC no. 6538 and Escherichia coli ATCC no 8739. “Light” MgO has lower bulk density (0.19 g/cm²) and higher surface area (97 g/m²) compared to standard periclase (“Mg-sig”), which has a bulk density of 0.43 g/cm² and surface area of 8.4 g/m². Changes in bacterial concentrations on CNC surfaces to which no magnesium-containing component were added were measured as a control (indicated by “CNC(2%)” in the tables). When different batches of material were used in the experimental runs, separate control experiments were performed. Results of the tests are shown in Tables 4 (S. aureus) and 5 (E. coli).

TABLE 4

| | Bacterial | Bacterial | Antimicrobial | |
|---|---|---|---|---|
| | Count | Count | activity | Average |
| | (zero time) | (24 hours) | Log | Log |
| Sample ID | CFU/ml | CFU/ml | Reduction | Reduction |
| CNC(2%) | 1.12E+07 | 3.00E+08 | N/A | N/A |
| | 1.42E+07 | 1.10E+08 | N/A | |
| | 1.28E+07 | 2.70E+08 | N/A | |
| CNC(2%) + | N/A | 1.06E+08 | 0.3 | 0.6 |
| Mg peroxide | N/A | 3.75E+07 | 0.8 | |
| (10%) | N/A | 4.70E+07 | 0.7 | |
| CNC(2%) + | N/A | 4.26E+00 | 4.3 | 3.9 |
| MgO-sig (10%) | N/A | 3.64E+00 | 3.6 | |
| | N/A | 3.94E+00 | 3.9 | |
| CNC(2%) (**) | 2.50E+07 | 1.80E+08 | N/A | N/A |
| | 2.00E+07 | 1.90E+08 | N/A | |
| | 1.85E+07 | 2.00E+08 | N/A | |
| CNC(2%) + | N/A | 3.30E+07 | 0.8 | 0.6 |
| Mg-light | N/A | 5.50E+07 | 0.5 | |
| (10%) | N/A | 8.60E+07 | 0.3 | |

TABLE 5

| | Bacterial | Bacterial | Antimicrobial | |
|---|---|---|---|---|
| | Count | Count | activity | Average |
| | (zero time) | (24 hours) | Log | Log |
| Sample ID | CFU/ml | CFU/ml | Reduction | Reduction |
| CNC (2%) | 2.10E+06 | 4.90E+08 | N/A | N/A |
| | 9.50E+05 | 4.65E+08 | N/A | |
| | 8.45E+05 | 4.40E+08 | N/A | |
| CNC(2%) + | N/A | 7.80E+06 | 1.8 | 2.05 |
| Mg-light | N/A | 1.05E+06 | 2.6 | |
| (10%) | N/A | 8.40E+06 | 1.7 | |
| CNC(2%) + | N/A | 2.60E+04 | 4.3 | 3.8 |
| MgO-sig | N/A | 1.09E+05 | 3.6 | |
| (10%) | N/A | 1.17E+05 | 3.6 | |
| CNC (2%) (**) | 1.55E+06 | 3.80E+08 | N/A | N/A |
| | 1.95E+05 | 3.25E+08 | N/A | |
| | 1.90E+05 | 3.65E+08 | N/A | |
| CNC(2%) + | N/A | 6.40E+07 | 0.7 | 0.6 |
| Mg peroxide | N/A | 7.30E+07 | 0.7 | |
| (10%) | N/A | 1.95E+08 | 0.3 | |

As can be seen from the results given in the table, MgO/NCC films containing standard MgO had significantly greater antibacterial activity than films containing “light” MgO or magnesium peroxide (reduction of bacterial population by ˜4 orders of magnitude relative to untreated NCC vs. reduction of 0.6-2 orders of magnitude).

### EXAMPLE 5

In order to test the effect of the MgO particle size on the antibacterial efficacy of the MgO/NCC film, a series of experiments in which films were prepared using as-received MgO, or as-received MgO milled to different sizes. The particle size distributions for the three batches are given in Table 6.

TABLE 6

| Material | d(0.1), μm | d(0.5), μm | d(0.9), μm |
|---|---|---|---|
| SIG (before sieving) | 0.78 | 6.40 | 35.18 |
| JM1 | 0.51 | 1.60 | 14.02 |
| JM2 | 0.69 | 2.36 | 26.81 |

Reference is now made to FIGS. 4A and 4B, which present a SEM picture and an EDS analysis, respectively of an MgO/NCC film comprising 20% “JM2” MgO particles. For comparison, an SEM picture of an identical NCC film without added MgO is shown in FIG. 4C. As can be seen in the figures, the MgO particles are homogeneously distributed in the NCC film.

MgO/NCC films were prepared as described above, except that the MgO content was 20%, and the NCC content of the suspension from which the films were produced was lowered to 1%. Runs in which the NCC content was 2% were also performed for comparison to the results given above. Results of tests of antibacterial efficacy against E. coli, S. aureus, and Pseudomonas aeruginosa 13388 are given in Tables 7, 8, and 9, respectively.

TABLE 7

| | Bacterial | Bacterial | Antimicrobial | |
|---|---|---|---|---|
| | Count | Count | activity | Average |
| | (zero time) | (24 hours) | Log | Log |
| Sample ID | CFU/ml | CFU/ml | Reduction | Reduction |
| CNC(1%) | 2.75E+06 | 2.45E+08 | N/A | N/A |
| | 2.45E+06 | 3.15E+08 | N/A | |
| | 2.55E+06 | 2.70E+08 | N/A | |
| CNC(1%) + | N/A | 4.55E+05 | 2.8 | 3.60 |
| Mg-SIG JM2 | N/A | 2.35E+04 | 4.1 | |
| (20%) | N/A | 3.20E+04 | 3.9 | |
| CNC(1%) | 3.60E+06 | 1.65E+08 | N/A | N/A |
| | 4.00E+06 | 3.65E+08 | N/A | |
| | 3.00E+06 | N/A | N/A | |
| CNC(1%) + | N/A | 4.00E+03 | 4.8 | 5.2 |
| Mg-SIG before | N/A | 1.00E+03 | 5.4 | |
| sieving (20%) | N/A | 1.00E+03 | 5.4 | |
| CNC(1%) | 2.60E+06 | 2.50E+08 | N/A | N/A |
| | 3.30E+06 | 2.25E+08 | N/A | |
| | 3.45E+06 | 3.35E+08 | N/A | |
| CNC(2%) + | N/A | 5.20E+06 | 1.7 | 3.35 |
| Mg-SIG before | N/A | 1.20E+04 | 4.3 | |
| sieving (20%) | N/A | 1.95E+04 | 4.1 | |

TABLE 8

| | Bacterial | Bacterial | Antimicrobial | |
|---|---|---|---|---|
| | Count | Count | activity | Average |
| | (zero time) | (24 hours) | Log | Log |
| Sample ID | CFU/ml | CFU/ml | Reduction | Reduction |
| CNC(1%) | 1.25E+07 | 1.16E+08 | N/A | N/A |
| | 9.00E+06 | 1.42E+08 | N/A | |
| | 1.35E+07 | 1.04E+08 | N/A | |
| CNC(1%) + | N/A | 1.04E+05 | 3.1 | 3.34 |
| Mg-SIG JM1 | N/A | 2.60E+04 | 3.7 | |
| (20%) | N/A | 6.00E+04 | 3.3 | |
| CNC(1%) | 1.01E+07 | 2.20E+08 | N/A | N/A |
| | 1.30E+07 | 1.60E+08 | N/A | |
| | 1.04E+07 | 2.40E+08 | N/A | |
| CNC(1%) + | N/A | 1.80E+05 | 3.1 | 2.73 |
| Mg-SIG JM2 | N/A | 6.20E+05 | 2.5 | |
| (20%) | N/A | 5.00E+05 | 2.6 | |
| CNC(1%) | 9.00E+06 | 2.05E+08 | N/A | N/A |
| | 1.14E+07 | 9.00E+08 | N/A | |
| | 1.07E+07 | 4.05E+08 | N/A | |
| CNC(1%) + | N/A | 4.05E+05 | 3.1 | 2.00 |
| Mg-SIG before | N/A | 4.20E+07 | 1.1 | |
| sieving (20%) | N/A | 1.04E+07 | 1.7 | |
| CNC(1%) | 9.00E+06 | 2.05E+08 | N/A | N/A |
| | 1.14E+07 | 2.00E+08 | N/A | |
| | 1.07E+07 | 4.05E+08 | N/A | |
| CNC(2%) + | N/A | 3.15E+05 | 2.8 | 2.40 |
| Mg-SIG before | N/A | 2.10E+05 | 3.0 | |
| sieving (20%) | N/A | 6.80E+06 | 1.5 | |

TABLE 9

| | Bacterial | Bacterial | Antimicrobial | |
|---|---|---|---|---|
| | Count | Count | activity | Average |
| | (zero time) | (24 hours) | Log | Log |
| Sample ID | CFU/ml | CFU/ml | Reduction | Reduction |
| CNC(1%) | 3.85E+06 | 8.90E+07 | N/A | N/A |
| | 2.80E+06 | 8.70E+07 | N/A | |
| | 1.75E+06 | 1.22E+08 | N/A | |
| CNC(1%) + | N/A | 8.15E+03 | 4.1 | 3.11 |
| Mg-SIG JM1 | N/A | 7.90E+05 | 2.1 | |
| (20%) | N/A | 7.30E+04 | 3.1 | |
| CNC(1%) | 3.85E+06 | 8.90E+07 | N/A | N/A |
| | 2.80E+06 | 8.70E+07 | N/A | |
| | 1.75E+06 | 1.22E+08 | N/A | |
| CNC(1%) + | N/A | 3.35E+05 | 2.5 | 3.56 |
| Mg-SIG JM2 | N/A | 1.11E+04 | 4.0 | |
| (20%) | N/A | 5.60E+03 | 4.2 | |
| CNC(1%) | 3.85E+06 | 8.90E+07 | N/A | N/A |
| | 2.80E+06 | 8.70E+07 | N/A | |
| | 1.75E+06 | 1.22E+08 | N/A | |
| CNC(1%) + | N/A | 3.15E+05 | 2.6 | 2.84 |
| Mg-SIG before | N/A | 2.13E+06 | 1.9 | |
| sieving (20%) | N/A | 8.70E+03 | 4.0 | |
| CNC(1%) | 3.85E+06 | 8.90E+07 | N/A | N/A |
| | 2.80E+06 | 8.70E+07 | N/A | |
| | 1.75E+06 | 1.22E+08 | N/A | |
| CNC(2%) + | N/A | 4.40E+03 | 4.3 | 3.10 |
| Mg-SIG before | N/A | 3.65E+05 | 2.4 | |
| sieving (20%) | N/A | 2.00E+05 | 2.6 | |

As can be seen from the results, MgO/NCC films containing MgO having particles of sizes on the order of microns effectively control bacterial populations (by ˜2-3 orders of magnitude relative to untreated NCC films). In the case of E. coli, reducing the particle size does not appear to have improved the efficacy of the antibacterial film. For S. aureus and P. aeruginosa, reducing the median particle diameter from 6.4 μm to 2.4 μm does appear to have improved the efficacy of the antibacterial film, while further reduction of the median particle diameter to 1.6 μm appears to have increased the efficacy against S. aureus but not against P. aeruginosa.

### EXAMPLE 6

The antibacterial activity of MgO/NCC films of the present invention against the pathogenic bacteria Salmonella Typhymurium ATCC 17028 and Listeria monocytogenes ATCC 19155 was investigated. MgO/NCC films were prepared as described above, prepared from a 1% NCC suspension and containing 20% “JM2” MgO. The antibacterial activity of the MgO/NCC film was measured according to the standard method of ISO 22196.

Results of the experiments are shown in Table 10, where U₀ is the concentration of viable bacteria (cells/cm²) on an untreated test specimen immediately after inoculation, Uₜ is the concentration of viable bacteria (cells/cm²) on an untreated test specimen measured 24 hours after inoculation, Aₜ is the concentration of viable bacteria (cells/cm²) on a test specimen treated with an MgO/NCC film of the present invention measured 24 hours after inoculation, and R is the reduction in the bacterial population.

TABLE 10

| Test Microorganism | log(U₀) | log(Uₜ) | log(Aₜ) | log(R) |
|---|---|---|---|---|
| Salmonella typhymurium | 4.43 | 3.73 | <1 | >2.73 |
| ATCC 17028 | | | | |
| Listeria monocytogenes | 4.05 | 3.11 | <1 | >2.11 |
| ATCC 19155 | | | | |

In these experiments, the maximum observable reduction in the population was limited by the smaller starting populations relative to those of the experiments reported above. Nonetheless, as can be seen from the results presented in the table, the MgO/NCC films of the present invention show significant antibacterial activity against Salmonella typhymurium and Listeria monocytogenes.

### EXAMPLE 7

In order to determine whether complete exposure of the MgO is necessary for the MgO/NCC film to show any antibacterial effect, the antibacterial efficacy of an MgO/NCC film in which the MgO was covered by an additional layer of NCC was examined.

MgO/NCC films were prepared according to the methods described above containing 20% “JM2” MgO from suspensions containing either 1% or 0.5% NCC. In addition, MgO/NCC films were prepared in which, after preparation of the MgO/NCC film, a second 120-nm thick NCC layer was deposited above the MgO. The antibacterial activity of the films against S. aureus was then measured. The results are summarized in Table 11.

TABLE 11

| | Bacterial | Bacterial | Antimicrobial | |
|---|---|---|---|---|
| | Count | Count | activity | Average |
| | (T = 0) | (T = 24 h) | Log | Log |
| Sample ID | CFU/ml | CFU/ml | Reduction | Reduction |
| CNC | 2.18E+07 | 2.17E+08 | N/A | N/A |
| | 1.98E+07 | | N/A | |
| | 2.25E+07 | 1.20E+07 | N/A | |
| CNC (1%) | N/A | 4.05E+04 | 3.5 | 4.3 ± 1.3 |
| Mg-SIG | N/A | 1.00E+02 | 6.1 | |
| JM2 (20%) | N/A | 5.45E+04 | 3.3 | |
| CNC (0.5%) | N/A | 3.45E+03 | 4.5 | 2.7 ± 1.4 |
| Mg-SIG | N/A | 8.90E+06 | 1.1 | |
| JM2 (20%) | N/A | 3.35E+05 | 2.5 | |
| CNC (1%) | N/A | 7.95E+04 | 3.2 | 2.3 ± 1.2 |
| Mg-SIG | N/A | 8.50E+04 | 3.1 | |
| JM2 (20%) | N/A | 2.11E+07 | 0.7 | |
| 120 nm | | | | |
| CNC layer | | | | |

As can clearly be seen from the results in the table, even when the MgO is coated with NCC and not directly exposed to the bacteria, the film shows antibacterial activity which although less than that of films produced without the additional NCC layer, remains significant.

Without being bound by theory, there appear to be two reasonable conjectures for the continued antibacterial activity of the NCC-coated MgO/NCC film. One possibility is that the NCC coating provides a source of nourishment for the bacteria on the film's surface, and that the bacteria consume the upper layer of NCC and are then killed when they contact the MgO that has been exposed by consumption of the NCC upper layer. Another possibility is that the upper layer does not completely cover the exposed MgO, and that observed antibacterial activity is due to the remaining exposed MgO. In either case, the results demonstrate that the antibacterial activity of the MgO/NCC film does not require that all of the MgO within the film be exposed on the film's surface.

1.-71. (canceled)

72. An antimicrobial chemical trap, said antimicrobial chemical trap comprising a film characterized by an upper surface and a lower surface, said film comprising an antimicrobial layer comprising nanocrystalline cellulose (NCC) and particles of an antimicrobial substance selected from the group consisting of MgO, Mg(OH)₂, mixtures thereof, and combinations thereof, said particles at least partially embedded within said film, wherein said particles are characterized by a median diameter of between 0.5 μm and 10 μm.

73. The antimicrobial chemical trap according to claim 72, wherein said antimicrobial trap is characterized by at least one of the following:
said particles of antimicrobial substance are at least partially coated with NCC;
said particles of antimicrobial substance are at least partially exposed on said upper surface; and,
said particles of antimicrobial substance are disposed such that microbes contacting said upper surface will contact at least a portion of said particles.

74. The antimicrobial chemical trap according to claim 72, wherein said film is characterized by a thickness of between 0.5 μm and 10 μm.

75. The antimicrobial trap according to claim 72, wherein said film comprises at least one additive.

76. The antimicrobial chemical trap according to claim 72, comprising a lower NCC layer comprising NCC but not MgO or Mg(OH)₂, said NCC layer in contact with said lower surface.

77. The antimicrobial chemical trap according to claim 76, wherein said lower NCC layer comprises at least one additive.

78. The antimicrobial chemical trap according to claim 72, comprising an upper NCC layer comprising NCC but not MgO or Mg(OH)₂, said NCC layer in contact with said upper surface.

79. The antimicrobial chemical trap according to claim 72, wherein said film comprises between 1% and 50% by weight of said antimicrobial substance.

80. The antimicrobial chemical trap according to claim 72, additionally comprising a substrate disposed such that said lower surface of said film is in contact with said substrate.

81. The antimicrobial trap according to claim 80, wherein said substrate is characterized by at least one of the following characteristics:
said substrate is not cationic;
said substrate is selected from the group consisting of glass, polymers, hybrid materials, biomaterials, dielectric materials, fibers, paper, cardboard, metal surfaces, cement, concrete, plaster, wood, food surfaces, and any combination of the above; and,
said substrate comprises at least one surface that has been pretreated to induce, permit, or hasten association of said surface and said lower surface of said film.

82. A method of producing an antimicrobial article, wherein said method comprises:
dispersing onto a substrate a first suspension, said first suspension comprising nanocrystalline cellulose (NCC) and an antimicrobial substance selected from the group consisting of particles of MgO, Mg(OH)₂, mixtures thereof, and combinations thereof, said particles characterized by a median diameter of between 0.5 μm and 10 μm, thereby producing an antimicrobial layer comprising an upper surface and a lower surface in which said antimicrobial substance is at least partially embedded within said antimicrobial layer; and, drying said antimicrobial layer.

83. The method according to claim 82, wherein said step of dispersing onto a substrate a first suspension comprises at least one of the following:
said step of dispersing onto a substrate a first suspension comprises dispersing said first suspension onto a substrate that is not cationic;
said step of dispersing onto a substrate a first suspension comprises dispersing said first suspension onto a substrate that is selected from the group consisting of glass, polymers, hybrid materials, biomaterials, dielectric materials, fibers, paper, cardboard, metal surfaces, cement, concrete, plaster, wood, food surfaces, and any combination of the above;
said step of dispersing onto a substrate a first suspension comprises pretreating said substrate followed by dispersing said first suspension onto said surface of said substrate; and,
said step of dispersing onto a substrate a first suspension comprises dispersing a first suspension that comprises an additive.

84. The method according to claim 82, wherein said method does not includes any step of dispersing said antimicrobial substance between said antimicrobial layer and said substrate.

85. The method according to claim 82, wherein said first suspension is characterized by at least one of the following:
said first suspension comprises between 0.1% and 15% NCC (w/v); and,
said first suspension comprises said antimicrobial substance and NCC in a ratio of between 10:100 and 40:100 (w/w).

86. The method according to claim 82, wherein said step of dispersing comprises dispersing said first suspension so as to produce an antimicrobial layer having a thickness of between 0.5 μm and 10 μm.

87. The method according to claim 82, comprising:
dispersing a second suspension comprising nanocrystalline cellulose (NCC) but not MgO or Mg(OH)₂ onto said substrate, thereby producing an NCC layer; and,
drying said NCC layer;
wherein said step of dispersing said first suspension comprises dispersing said first suspension onto said NCC layer.

88. The method according to claim 87, wherein said step of dispersing said first suspension is performed subsequent to said step of drying said NCC layer.

89. The method according to claim 87, wherein at least one of said first suspension and said second suspension comprises between 0.1% and 3% NCC (w/v).

90. A method of controlling a microbial population, comprising:
obtaining an antimicrobial chemical trap comprising a film characterized by an upper surface and a lower surface, said film comprising an antimicrobial layer comprising nanocrystalline cellulose (NCC) and particles of an antimicrobial substance selected from the group consisting of MgO, Mg(OH)₂, mixtures thereof, and combinations thereof, said particles characterized by a median diameter of between 0.5 μm and 10 μm and at least partially embedded within said film; and,
exposing a population of microbes to said upper surface of said antimicrobial trap, thereby exposing said microbes to antimicrobial activity arising from said antimicrobial substance.

91. The method according to claim 90, wherein said step of exposing a population of microbes to said upper surface of said antimicrobial trap comprises placing said antimicrobial layer in a location such that said upper surface is accessible to microbes.
